(19) United States
(12) Patent Application Publication
(10) Pub. No.: US 2011/0198996 A1
(43) Pub. Date: Aug. 18, 2011

(54) Lighting Lamp Apparatus With Replaceable Fuse Element

(76) Inventor: Wen-Cheng Lai, Taoyuan (TW)

(21) Appl. No.: 12/704,553

(22) Filed: Feb. 12, 2010

(51) Int. Cl. H01J 7/44

(52) U.S. Cl. 315/74

(57) ABSTRACT

A lighting lamp apparatus with replaceable fuse element is provided, including a light base having a light source, a light focusing shade engaged to top of the light base, and a light head, engaged to bottom of the light base as an electrical connection interface of the entire apparatus to a light bulb installation part, a circuit set being placed between said light head and said light base, where the circuit set further includes a fuse. The fuse is placed inside a fuse base, and one end of said fuse base is exposed outside of surface of said light head for easy replacement of the fuse.

### FIELD OF THE INVENTION

The present invention generally relates to alighting lamp apparatus, and more specifically to a lighting lamp with a screw head for light bulb and a fuse element in the lamp shell for replacing fuse from outside.

### BACKGROUND OF THE INVENTION

The conventional lighting lamp apparatus with screw head for light bulb is a widely used product. As more types of lighting sources are developed, energy-saving light bulb, LED and cold cathode fluorescent lamp are available in addition to conventional tungsten light bulb. These different types all use the same standard screw head specification for seating the light bulb, and the lighting lamp apparatus usually do not include any safety circuitry. The lifespan of the light bulbs on the lighting lamp apparatus usually depends on the design of the light bulbs as well as the circuit design. Therefore, different types of light bulbs are prone to malfunction due to the mismatching with the circuit and need to be replaced by a specific type of light bulb, which leads to additional waste of resources.

As the LED and cold cathode fluorescent lamp are becoming more available, the long lifespan of this type of light bulbs increase the popularity. However, the problem of conventional light lamp apparatus, such as, sudden voltage surge, unstable voltage or related current problems, may easily short circuit the light bulbs. This contradicts the purpose of the design of the long lifespan light bulbs. Therefore, it is imperative to devise a lighting lamp apparatus suitable for various types of light bulbs while maintaining the designed lifespan of the life bulbs.

### SUMMARY OF THE INVENTION

The primary object of the present invention is to provide a lighting lamp apparatus able to effectively utilize the lifespan of the light bulbs. The lighting lamp apparatus of the present invention, while having a standard screw head design, has a replaceable fuse element. When the fuse is short-circuited due to the voltage or current problem, the fuse can be easily replaced and the light bulb is shielded from the voltage and current problem common in the conventional lighting lamp apparatus. In this manner, the long lifespan of the light bulb, such as, LED or cold cathode fluorescent lamp, can be fully utilized to reduce the waste and environment stress.

The present invention includes a via hole on the shell of the lighting lamp apparatus so that fuse can be easily accessed for replacement.

The lighting lamp apparatus with replaceable fuse element of the present invention includes a light base, a light source, a light focusing shade, a circuit set and a light head. The circuit set includes a protective circuit, a bridge rectifier circuit, power transformer circuit and load circuit, where the protective circuit is electrically connected to a fuse to provide protection against current overload and short circuit protection.

The fuse is housed inside a fuse base and the fuse base is located inside the light head. The surface of the light head has a via hole so that one end of the fuse base is fixed to the via hole, i.e., exposed on the surface of light head. In this manner, to replace the fuse, the lid of the fuse base is opened, the burned fuse is removed and replaced with the new one without separating the light head from the light base.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the assembled lighting lamp apparatus with replaceable fuse element of the present invention;

FIG. 2 shows a schematic exploded view of the lighting lamp apparatus with replaceable fuse element of the present invention;

FIG. 3 shows a schematic view of another embodiment of assembled lighting lamp apparatus with replaceable fuse element of the present invention;

FIG. 4 shows a schematic view of the circuit of the lighting lamp apparatus with replaceable fuse element of the present invention;

FIG. 5 shows a cross-sectional view of the first embodiment of lighting lamp apparatus with replaceable fuse element of the present invention; and

FIG. 6 shows a schematic view of replacing fuse according to the present invention.

### DETAILED DESCRIPTION OF THE PREFERRED EMBODIMENTS

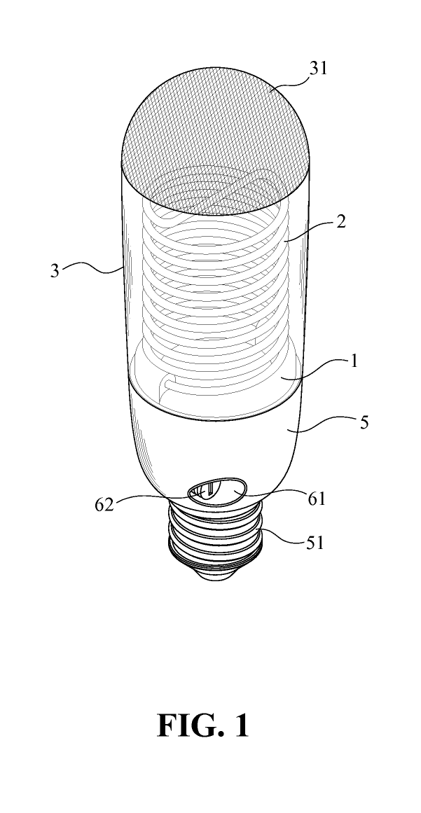

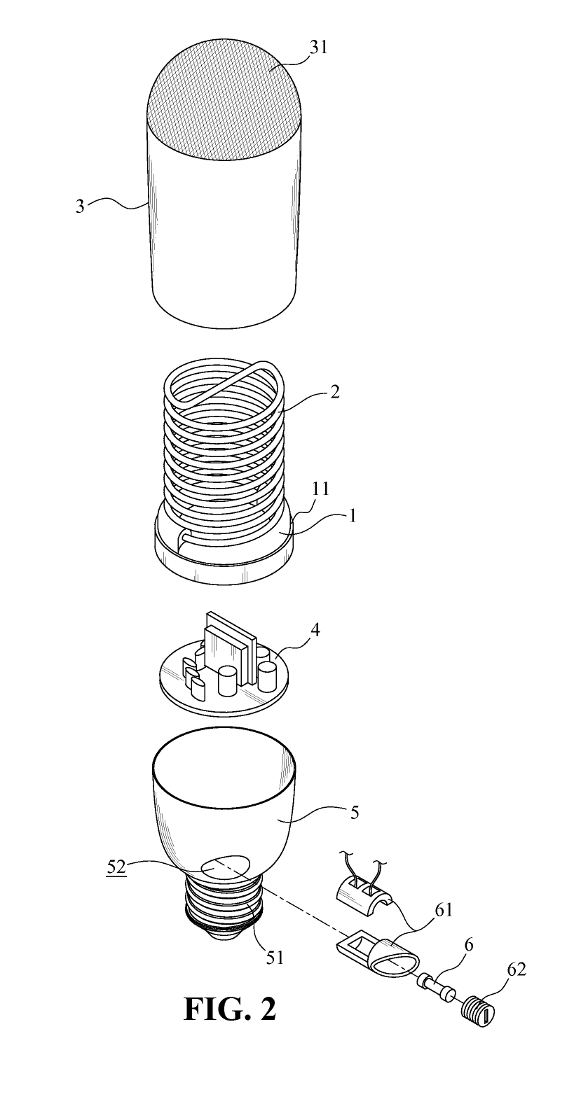

FIG. 1 and FIG. 2 show a schematic assembly view and a schematic exploded view of the lighting lamp apparatus with replaceable fuse element of the present invention, respectively. As shown in FIG. 1 and FIG. 2, lighting lamp apparatus with replaceable fuse element of the present invention include a light base 1, a light source 2, a light focusing shade 3, a circuit set 4 and a light head 5, where circuit set 4 includes a fuse 6. Light base 1, light source 2, light focusing shade 3 and light head 5 are not limited to any specific design, but the structures of each component is made to match each other correspondingly to be assembled.

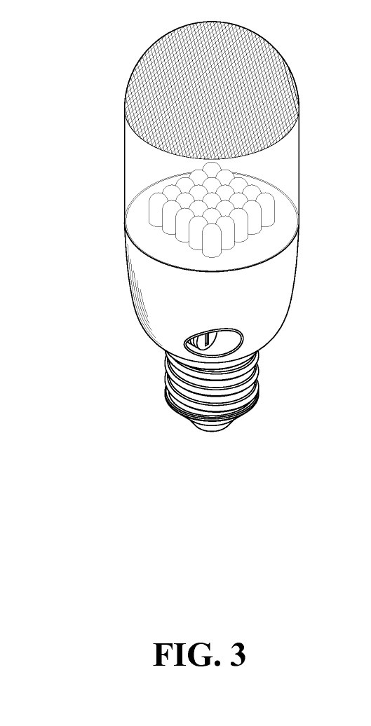

In the above embodiment of the present invention, light base has the shape of a hemisphere. Light source 2 is fixed to light base 1. Light source 2 of the present invention is not restricted to any specific type. For example, the present embodiment can use either cold cathode fluorescent lamp or LED (as shown in FIG. 3). Light focusing shade 3 must be made of material with high transmittance, preferably, colorless and transparent. The shape of light focusing shade 3 must match light base 1. In the above embodiment, the shape of light focusing shade 3 is a hollow circular tube, with the top shaped as a hemisphere. The outer surface of the top has a regular diamond pattern so as to diffuse the light uniformly. Light focusing shade 3 covers light source 2. The opening of light focusing shade 3 and light base 1 must match so that light focusing shade 3 is fixed to light base 1 to cover light source 2. In the above embodiment, light base 1 includes a ring trench 11 for the opening of light focusing shade 3 to insert and engage. Light head 5 is an electrical connection interface to an light installation part (not shown). The light head in the present invention is E27 type, or other light head of screw type. Conductive wire of light source 2 passes through light base 1, and is electrically connected to circuit set 4 situated between light base 1 and light head 5.

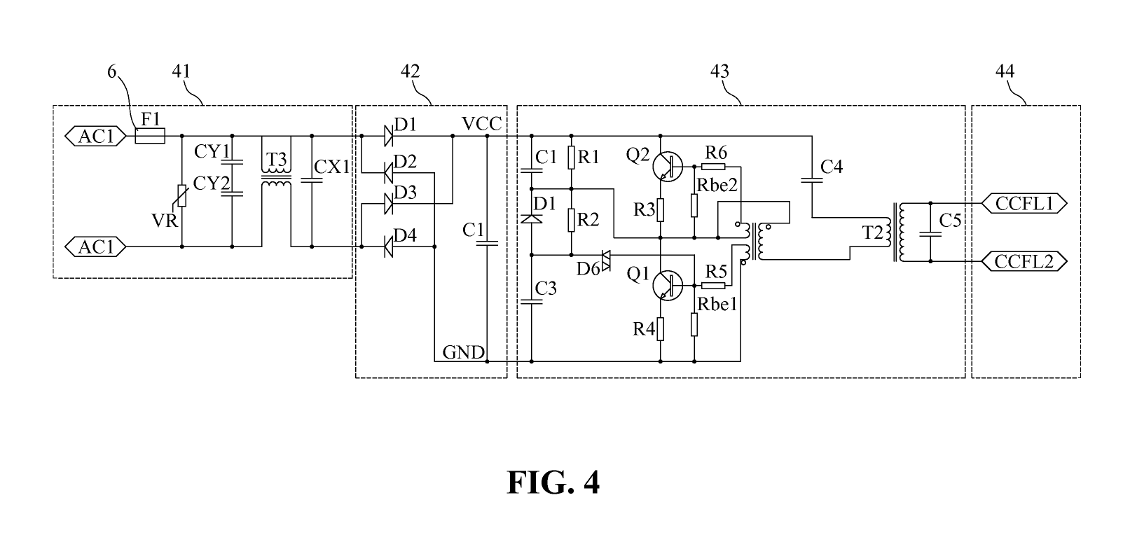

FIG. 4 shows a schematic view of the circuit of the lighting lamp apparatus with replaceable fuse element of the present invention. Circuit set 4 includes a protective circuit 41, bridge rectifier circuit 42, power transformer circuit 43 and load circuit 44. Protective circuit 41 includes fuse 6 to provide protection against current overload and short circuit to the entire lighting lamp apparatus.

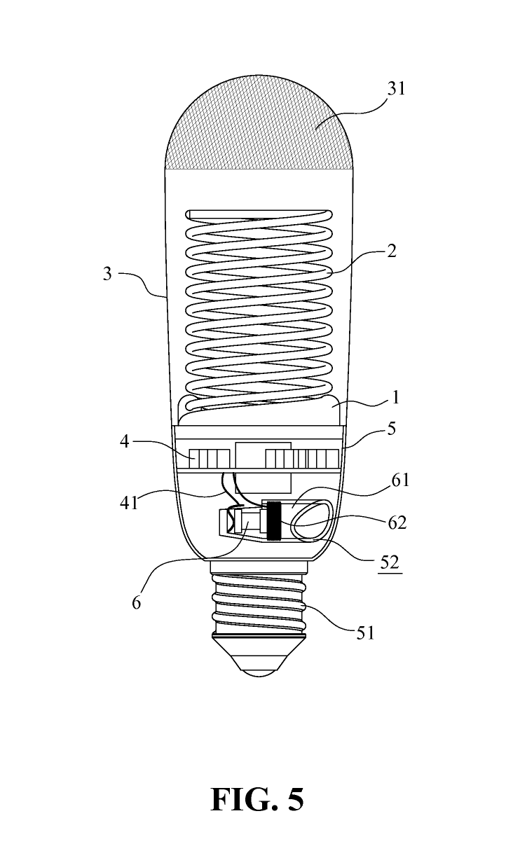

As shown in FIG. 5, fuse 6 is placed inside a fuse base 61. In the present invention, the way fuse base 61 is fixed to light head 5 is to open a via hole 52 on the surface of light head 5 in a slanted direction, and then one end of fuse base 61 passes from inside of light head 5 through via hole 52 to expose outside if light head 5. The other end of fuse base 61 is fixed to inside of light head 5. More specifically, fuse base 61 requires an opening or a hole for a conductive wire to run between fuse 6 and circuit set 4. In addition, to prevent fuse 6 from falling off fuse base 61, a cover 62 is included to seal the opening of fuse base 61. The engagement between cover 62 and the opening of fuse base 61 is not limited to any specific structure as long as cover 62 can be removed and engaged tightly. Also, additional patterns or convex marks can be added to the surface of cover for easy grasping manually or by tool.

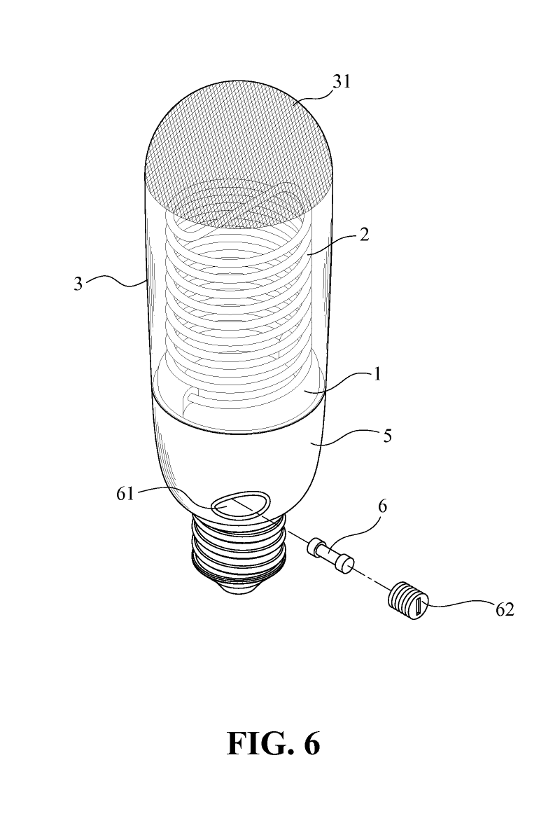

FIG. 6 shows a schematic view of replacing fuse according to the present invention. With the above fuse base design, to replace fuse 6, cover 62 of fuse base 61 is opened, the burned fuse is removed and new fuse is placed. In this manner, the lighting lamp apparatus of the present invention can prevent the entire light lamp apparatus from voltage or current surge and effectively utilize the long lifespan of the LED or cold cathode fluorescent lamp.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A lighting lamp apparatus with replaceable fuse element, comprising: a light base, a light source, a light focusing shade engaged to top of said light base, and a light head, engaged to bottom of said light base, a circuit set being placed between said light head and said light base, where said circuit set further comprising a fuse, said fuse being placed inside a fuse base, one end of said fuse base exposed outside of surface of said light head for easy replacement of said fuse.

2. The apparatus as claimed in claim 1, wherein said fuse base further comprise a cover to seal said fuse inside said fuse base, and said cover can be opened manually or with a tool.

3. The apparatus as claimed in claim 1, wherein top of said light focusing shade is shaped as a hemisphere, with surface forming diamond patterns to diffuse light uniformly.

4. The apparatus as claimed in claim 1, wherein said light head is a light head with screw connector.
